(19) United States
(12) Patent Application Publication
(10) Pub. No.: US 2009/0144256 A1
(43) Pub. Date: Jun. 4, 2009

(54) Workflow control in a resource hierarchy

(76) Inventors: Moises Cases, Austin, TX (US); Candice Leontine Coletrane, Durham, NC (US); Daniel N. de Araujo, Cedar Park, TX (US); Bhyrav Murthy Mutnury, Austin, TX (US); William Gabriel Pagan, Durham, NC (US)

Correspondence Address: IBM CORP (YA);C/O YEE & ASSOCIATES PC, P.O. BOX 802333, DALLAS, TX, 75380, US

(21) Appl. No.: 11/947,382

(22) Filed: Nov. 29, 2007

(51) Int. Cl. G06F 7/06

(52) U.S. Cl. 707/5

(57) ABSTRACT

Illustrative embodiments provide a computer implemented method, an apparatus and a computer program product for workflow management control in a resource hierarchy. In one embodiment, the computer implemented method comprises, receiving data, from a plurality of target data sources, into a collection, and synthesizing the received data in the collection to establish a resource hierarchy. The collection is then queried, using criteria in a request for a resource from a requester to provide a selected resource from the collection, forming a response, the selected resource of the response being a best fit result, and returning the response to the requester.

### BACKGROUND OF THE INVENTION

1. Field of the Invention

The present invention relates generally to an improved data processing system, and in particular to a computer implemented method, an apparatus and a computer program product for workflow management control in a resource hierarchy.

2. Description of the Related Art

A typical problem for medium to large scale organizations lies in how work tasks are assigned. For example, it is common practice for a support call to be handled by an arbitrarily available operator in the call center. While this arrangement may be an acceptable choice at first, a problem may arise when the selected operator is unable to resolve the customer call. In this case, the operator must find someone with more experience in the subject matter or someone dealing with the correct subject matter to assist. There is a further need to improve task assignment throughout an organization so the task can be handled optimally. Current methods often involve an arbitrary assignment of tasks to persons with increasingly higher skill levels within the organizational hierarchy. The hierarchy is typically, statically defined within the organization.

Today, tasks in an organization are typically handled non-scientifically, utilizing classical business processes not suited for knowledge-based or engineering services. For example, when a task comes to an operator or a node in one sphere of reference, such as a level 1, and when that node cannot resolve the issue or does not have the needed solution, the task gets sent to the next defined level, for example, level 2. The re-assignment within the hierarchy typically occurs without ensuring there are skilled operators in the same sphere, such as level 1, who can address the task request. Thus, the business outcome may not be fully capitalized, and in some cases, not optimized in terms of return on investment, and resource utilization. Accordingly, a need is present for a method and apparatus for minimizing problems associated with assigning tasks, which overcomes the problems discussed above.

### SUMMARY OF THE INVENTION

Illustrative embodiments provide a computer implemented method, an apparatus and a computer program product for workflow control in a resource hierarchy. In one illustrative embodiment, the computer implemented method comprises, receiving data, from a plurality of target data sources, into a collection to form received data, synthesizing received data in the collection to establish the resource hierarchy. The method further comprises selecting a resource from the collection, to form a response to a request for the resource from a requester, and returning the response to the requester.

In another illustrative embodiment, the data processing system comprises a bus, a memory connected to the bus, wherein the memory contains computer usable program code, a communications unit connected to the bus, a display connected to the bus, a persistent storage connected to the bus, and a processor connected to the bus. The processor executes the computer usable program code to receive data, from a plurality of target data sources, into a collection to form received data, synthesize received data in the collection to establish a resource hierarchy, select a resource from the collection, to form a response to a request for the resource from a requester, and return the response to the requester.

In another illustrative embodiment, the computer program product comprises computer usable program code tangibly embodied on a computer usable recordable type medium. The computer usable program code comprises computer usable program code for receiving data, from a plurality of target data sources, into a collection to form received data, computer usable program code for synthesizing received data in the collection to establish a resource hierarchy, computer usable program code for selecting a resource from the collection, to form a response to request for the resource from a requester, and computer usable program code for returning the response to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is block diagram of workflow control components representative of an illustrative embodiment;

FIG. 4 is a flowchart of a workflow control process overview, in accordance with an illustrative embodiment;

FIG. 5 is a flowchart of a data collection flow within the workflow control process overview of FIG. 4, in accordance with an illustrative embodiment; and

FIG. 6 is a flowchart of a selection process within the workflow control process overview of FIG. 4, in accordance with an illustrative embodiment.

### DETAILED DESCRIPTION OF THE PREFERRED EMBODIMENT

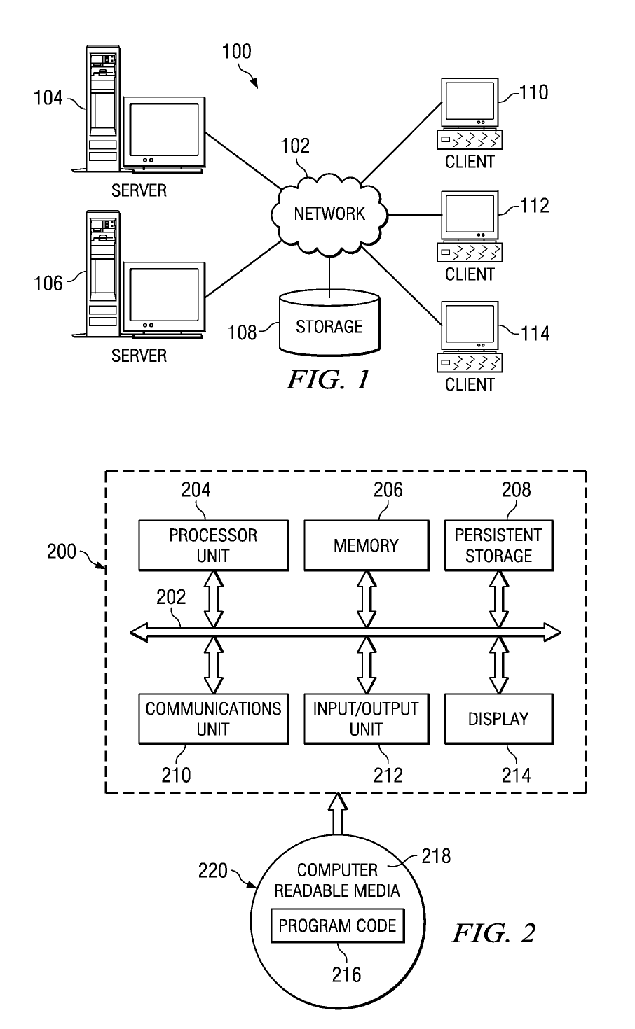

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 for example, may be used in an embodiment to provide server 106 for receiving data, from a plurality of target data sources, such as other servers and clients 110, 112, and 114. The received data may then be synthesized to establish a resource hierarchy that may be queried in response to a request by a client 110 for a resource. The response may then be return through the network 102 to the requester client 110. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

In an embodiment, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

An illustrative embodiment provides a capability for aggregating data collected from a plurality of data sources, to form a collection describing a plurality of resources, each resource comprising an associated set of attributes. The collection may then be processed to further synthesize a ranking of the resources to establish a resource hierarchy. Responsive to receiving a request for a resource, the collection may be queried to provide a “best fit” resource response to the requester. The best fit determination is performed in accordance with request criteria against the resource hierarchy of the collection.

For example, in an illustrative embodiment using a call center, a plurality of data sources on servers, such as server 106 of FIG. 1, may be accessed via network 102 to produce a collection that is also stored on a server. The collection, comprising data describing capabilities of the call center operators, may then be accessed by a request from a user such as client 110, for resources to be allocated to assistance in resolving an issue associated with the user.

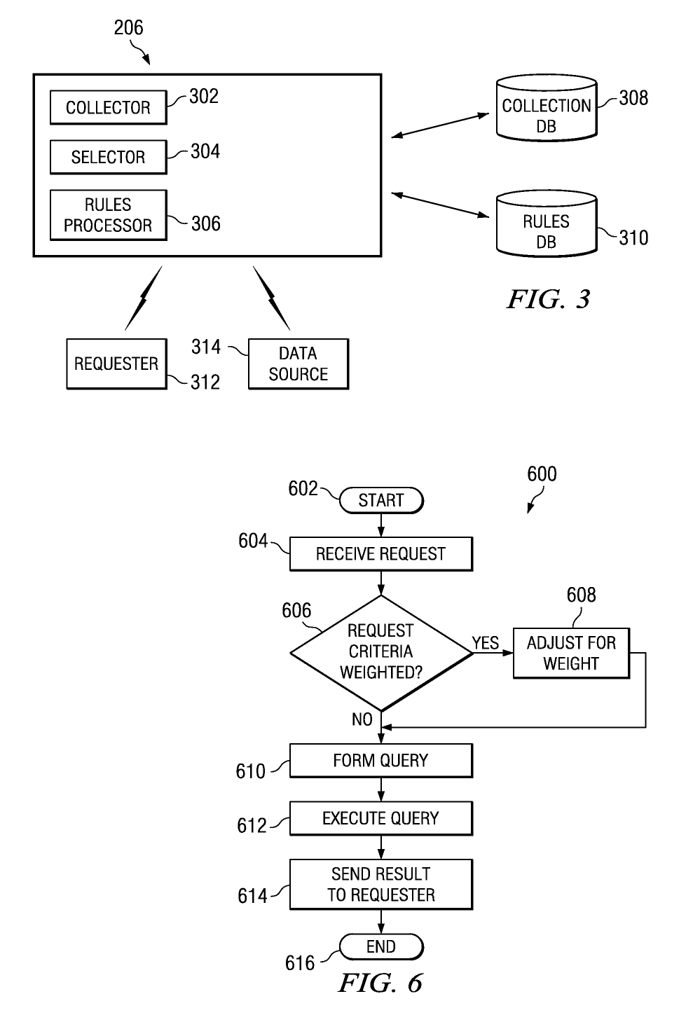

With reference now to FIG. 3, a block diagram of workflow control components representative of an illustrative embodiment is shown. Components depicted may be implemented in a system, such as data processing system 200 of FIG. 2, wherein memory 206 contains components of a collector 302, selector 304, and rules processor 306. A collection database (DB) 308, a rules database (DB) 310, data source 314 and requester 312 are in communication with the components of system 200.

Collector 302 provides capabilities to retrieve or receive data from a plurality of data sources, such as data source 314. Collector 302 includes capabilities to analyze data on input, as well as extract relevant portions from the target data sources.

For example, during collection a personnel database may be accessed in which only portions of a respective record are of interest. The analyzing and extracting portion of collector 302 would only retrieve data from specific fields, such as job title, rating, and location, while ignoring other fields of personal information.

In a similar manner, if a skills database was a target data source 314, the analyzing and extracting portion may collect blocks of information related to skill proficiency using products and tools, interpersonal skills and areas of study. By further example, data related to relationships, such as work group assignments, projects, awards, and other forms of recognition may be accumulated to form a formal, as well as an informal composite of a resource, such as a skilled worker.

Formal data may be termed hard data, such as that which is typically tracked and quantified, such as billing rate, education level, certifications, and job title. Informal data may be termed soft data, such as that which describes experience in the form of time on the job, group affinities, and job responsibilities.

While collector 302 is processing incoming data, collector 302 also further refines the collected data by synthesizing the aggregation into a hierarchical collection. The synthesizing may be achieved through processing using rules processor 306. Rules processor 306 applies predetermined conditional processing to portions of the aggregated data. Rules may generally be described in the form of a condition and an action. If the condition is met the respective action is performed. Rules processor 306 functions in conjunction with rules database (DB) 310 containing the rules and associated actions. Rules are typically focused on an attribute basis, therefore when an attribute is processed a respective rule is invoked to provide the configurable processing needed.

For example, when an attribute of a defined resource, such as a call center operator, is “availability” and the data received includes days absent, as well as vacation, then a rule may be defined to calculate the time the worker was available. A corresponding calculation may be defined as subtracting the sum of days absent plus vacation days from the predetermined total work time in days. The available result may then be expressed in different forms, such as, an actual value or percentage, depending upon the usage requirement.

In a similar manner, other data may be synthesized where direct input cannot provide the desired attribute and value needed. Collector 302 may also collect informal data as opposed to the formal data of the availability example. In the informal example, a skilled worker may have been part of a project group, wherein the data captured could be noted as a subset of the project experience information. Such information may be useful in the establishment of teams, wherein the information in the collection may be used to indicate a skilled worker has worked with another skilled worker before based on project affiliation. This information may be used to synthesize a value for a peer relationship attribute.

Selector 304 provides a querying capability to sift through the collection database (DB) 308 entries to meet criteria specified in a request. Requests may be initiated by users or other processes in the form of requester 312. In one embodiment, selector 304 may be a structured query language (SQL) based interface in which a requester may provide basic search criteria. The search criteria may be further provided with a weighting indicator for the criteria to assign a priority to the criteria.

For example, if the criteria submitted included a request for a level 1 respondent with a minimal cost, but a weighting factor was applied to the respondent factor, the minimal cost component would have less significance in the search outcome. In this manner, the selection criteria can be further tuned to the needs of the requester, allowing for the use of templates with an overriding capability.

By creating a database used with a dynamic social network of resources, rather than a statically pre-defined organization, a user at a point in the social network can typically make intelligent decisions in real time about how to best forward work tasks to someone else in the organization. The capability typically leads to more intelligent decisions of selecting a set of optimal resources for a given task.

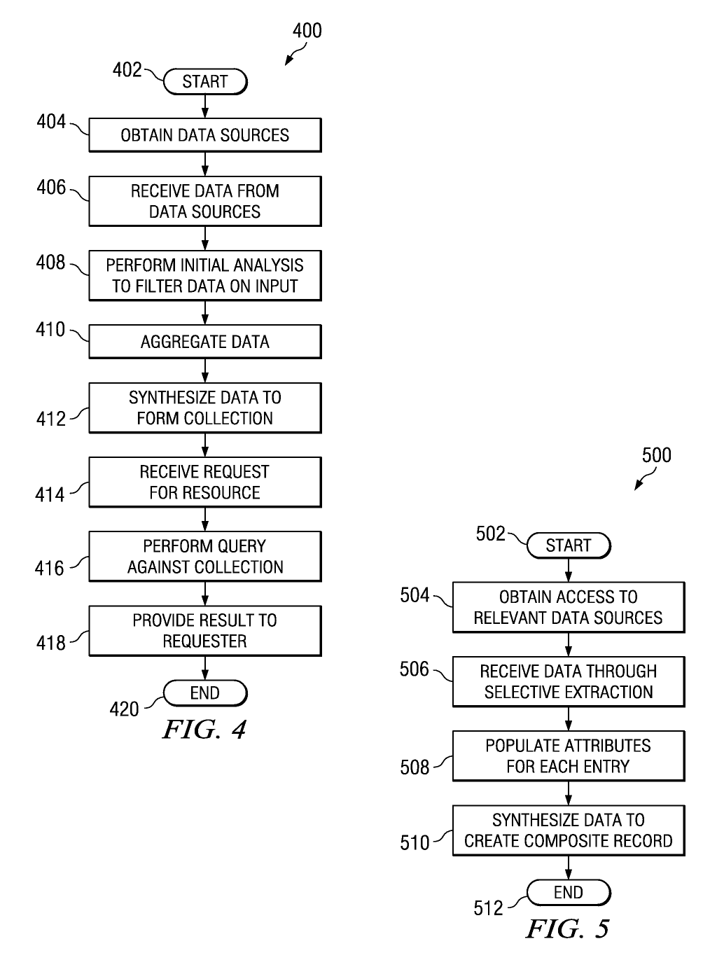

With reference now to FIG. 4, a flowchart of a high level process overview, in accordance with an illustrative embodiment is shown. Process 400 of FIG. 4 is performed by the workflow control components of FIG. 3. Process 400 begins (step 402) and moves to obtain data sources (step 404). The data sources are typically a plurality of databases and other forms of data including that which may be submitted directly. Typical data sources include repositories already in existence to support other functions, such as personnel and project management. For example, personnel data including job title, job responsibilities, job rating, and location information may be extracted from a personnel database. Project related databases may yield project success indicators, role, worker affiliation, responsibilities, contribution, start and end dates, and training information.

Having obtained data sources in step 404, process 400 begins to receive data from the target data sources (step 406). During receipt of the data, process 400 performs an initial analysis to filter the data on input (step 408). Data filtering ensures only data that meets the requirements corresponding to the attributes in the collection database is collected. Other fields or portions of the target data sources are ignored or otherwise not allowed to be extracted or received.

Data aggregation occurs completing the filling of values for respective attributes for which data can be immediately provided (step 410). Data aggregation is the placement of data values into respective columns or fields within a particular row or record. Obtaining the raw data from the target data sources and placing values within their respective locations does not complete the collection activities. Other data may then be calculated or synthesized to form the collection (step 412). For example, if a worker was available on an average of four days of every five, then a synthesized value of “0.8” for availability may be plugged into the value location for that worker's availability entry. In another example, a worker's home address may be compared to a work location address to synthesize a “proximity to work” attribute value. Such a value may be useful for emergency call situations.

A request for a particular resource to address a need of a requester is received (step 414). The request is formatted into a structured query language query and submitted to the collection database for resolution (step 416). The query may also include a modification in the form of a weighting factor. As indicated earlier, the weighting factor applied to the selection criteria alters the outcome of the query by prioritizing the criteria during execution against the collection database. A result from the query is obtained and provided to the requester (step 418) with process 400 terminating thereafter (step 420).

With reference to FIG. 5, a flowchart of a data collection flow within the process overview of FIG. 4 is shown in accordance with an illustrative embodiment. Process 500 is a subset of the workflow control process 400 of FIG. 4. Process 500 may be viewed as the input phase of the workflow control process. Process 500 begins (step 502) and obtains access to the relevant data sources (step 504). Relevant data sources are the target data sources identified as those which provide the data directly or indirectly to populate the entries of the collection database.

Target data sources may be viewed as a plurality of data sources that may be in communication with the collection process 500. Data extraction and receipt is performed through selective processing of the target data sources (step 506). Selective processing may be performed by typical processing, such as scripts or agents that can access the target data. Data from the target sources may be mined through programmatic queries or by way of bulk loading as the situation warrants. Various techniques may be used to effect the necessary data collection.

Having obtained the data in step 506, the attributes of each entry are then populated with the results of the data acquisition (step 508). In cases where the data obtained is not suited for a particular attribute, a value may be further synthesized (step 510). Process 500 terminates thereafter (step 512).

Synthesizing the data values may involve forms of data reduction, transformation, interpretation, and substitution. For example, data reduction may include summation of a number of entries into a single value. In another example, data transformation may include changing an absolute value, such as the availability example, into a percentage. Data interpretation may be seen in a relationship expression where a range of values, for instance 1 to 5, may be used to express the strength of the relationship. For example, in a case where a worker was shown to have worked with another group on one occasion, a value of “1” may be used, but when the worker was involved in several occasions a value of 5 may be chosen. Data substitution may occur where the source data does not work well in further calculations. For example, when a worker performs in a specific role, the role identifier may not be useful, but a numeric substitute may.

FIG. 6 is a flowchart of a selection process within the process overview of FIG. 4, in accordance with an illustrative embodiment. Process 600 is a subset of the workflow control process 400 of FIG. 4. Process 600 may be viewed as the output phase of the workflow control process.

Process 600 begins (step 602) and receives a request for a resource allocation or assignment (step 604). The request is analyzed to determine whether the content includes any weighting factors with the selection criteria (step 606). If weighting factors are present, a “yes” is returned and process 600 moves to adjust the query information to include the weighting information (step 608). Having adjusted the query information to include weighting information, the query is then formed as a set of structured query language statements (step 610). The set may be one or more than one statement as required depending upon the request received.

If the weighting factors are not present, a “no” is returned in step 606 and the set of structured query language statements is formed (step 610). The structured query language statements are then executed against the information contained in the collection database 308 of FIG. 3. Execution of the query is performed and managed by a database management component associated with and managing collection database 308. The results of the query are then returned to process 600 which in turn passes the result back to the requester (step 614). Process 600 terminates thereafter (step 616).

The performance of the query and the adjustment of the query input based on the presence of weighting factors may include rules and the use of a rules processor, such as rules processor 306 and rules from rules database 310 of FIG. 3. Rules processing provides a capability of selectively modifying the query input from the requester into a form more suited for processing. The rules usage also is used to alter the input. For example, when a request is received with selection criteria including a value of “low” weighting for an attribute of cost, an adjustment may be performed to set the value to a numeric value within a predetermined range.

In another example, when a requested selection criteria specifies a predetermined combination of attributes and values, adjustments performed by rules processing may further refine the query. For example, criteria may comprise a location having a close proximity to a client, a specific skill requiring a high level of expertise, a high availability requirement for the resource, and an affinity for a predetermined project or group of other resource, which would cause rules to override other selection criteria and focus on the significant factors specified.

Processing of the selection criteria by way of rules enables conditional processing to modify the input prior to submission to the database query mechanism. Pre-processing the selection criteria typically improves the selection processing and the output of the selection.

Illustrative embodiments provide a capability for aggregating data collected from a plurality of target data sources to form a collection describing the plurality of resources, each resource comprising an associated set of attributes with respective values. The collection may then be processed to further synthesize a ranking of the resources to establish a resource hierarchy. Responsive to receiving a request for a resource, the collection may be queried to provide a “best fit” resource response to the requester. The best fit determination is performed in accordance with request criteria against the resource hierarchy of the collection. The request criteria may be pre-processed to improve the selection processing of the query when executed.

By creating a database collection based on a dynamic social network of resources, rather than a statically pre-defined organization, a user, at a point in the social network, may typically make intelligent decisions in real time about how to best forward work tasks to someone else in an organization. The capability typically leads to more intelligent decisions of selecting a set of optimal resources for a given task.

In an illustrative embodiment, a social network is created wherein every person authorized to handle a work item is a node in the network. Each node in the network also has an assigned score or weight that is based on several factors related to handling the task at hand. For example, an employee with 10 years of experience in the subject matter might have more weight in the organization than a new hire. Other factors may include the person's job code, pay band, success rate, total number of completed tasks, yearly evaluations, or other suitable factors.

The organization may be sorted into a predetermined number of levels or tiers to form a hierarchy according to the desires of the business administration. For example, the bottom 45 percent of the organization may be considered “level 1” and available as first level support to handle a task or as a least cost option. The next 35 percent may be defined as level 2 with the remaining 20 percent being level 3. As a task moves up in level, the amount charged to a customer may increase accordingly.

As new resources are requested to handle new or existing tasks, the collection database can be queried for the weight of all available nodes and resources, in the form of skilled workers, to be selected from the available pool at any level specified by the requester. In this manner, the requester may control the needed level of experience, as well as the cost the requester is willing to incur. Further, the collection database may change dynamically as the database is updated, on an ongoing basis, to more accurately represent the skills and experience of the business, enabling more intelligent resource allocation decisions to be made.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for workflow control in a resource hierarchy, the computer implemented method comprising:
receiving data from a plurality of target data sources into a collection to form received data;
synthesizing received data in the collection to establish the resource hierarchy;
selecting a resource from the collection, to form a response to a request for the resource from a requester; and
returning the response to the requester.

2. The computer implemented method of claim 1, wherein the plurality of target data sources further comprises:
a plurality of resources in which each resource comprises a set of attributes with associated values.

3. The computer implemented method of claim 1, wherein the plurality of target data sources further comprises:
a dynamic social network of resources.

4. The computer implemented method of claim 1, wherein synthesizing data in the collection further comprises:
processing the received data in the collection by one or more methods including data reduction, data transformation, data interpretation, and data substitution.

5. The computer implemented method of claim 1, wherein selecting a resource from the collection further comprises:
adjusting criteria of a query to include weighting information;
forming the query as a set of structured query language statements; and
executing the set of structured query language statements against the collection.

6. The computer implemented method of claim 1, wherein the resource of the response is a “best fit” result.

7. A data processing system for workflow control in a resource hierarchy, the data processing system comprising:
a bus;
a memory connected to the bus, wherein the memory contains computer usable program code;
a communications unit connected to the bus;
a display connected to the bus;
a persistent storage connected to the bus;
a processor connected to the bus, wherein the processor executes the computer usable program code to:
receive data, from a plurality of target data sources, into a collection to form received data;
synthesize received data in the collection to establish the resource hierarchy;
select a resource from the collection, to form a response to a request for the resource from a requester; and
return the response to the requester.

8. The data processing system of claim 7, wherein the plurality of target data sources further comprises:
a plurality of resources in which each resource comprises a set of attributes with associated values.

9. The data processing system of claim 7, wherein the plurality of target data sources further comprises:
a dynamic social network of resources.

10. The data processing system of claim 7, wherein the processor executes the computer usable program code to synthesize data in the collection further comprises:
process the received data in the collection by one or more methods including data reduction, data transformation, data interpretation and data substitution.

11. The data processing system of claim 7, wherein the processor executes the computer usable program code to select a resource from the collection further comprises:
adjust criteria of a query to include weighting information;
form the query as a set of structured query language statements; and
execute the set of structured query language statements against the collection.

12. The data processing system of claim 7, wherein the resource of the response is a “best fit” result.

13. A computer program product for workflow control in a resource hierarchy, the computer program product comprising computer usable program code tangibly embodied on a computer usable recordable type medium, the computer usable program code comprising:
computer usable program code for receiving data, from a plurality of target data sources, into a collection to form received data;
computer usable program code for synthesizing received data in the collection to establish a resource hierarchy;
computer usable program code for selecting a resource from the collection, to form a response to a request for the resource from a requester; and
computer usable program code for returning the response to the requester.

14. The computer program product of claim 13, wherein the computer usable program code for receiving data from a plurality of target data sources further comprises:
computer usable program code for a plurality of resources in which each resource comprises a set of attributes with associated values.

15. The computer program product of claim 13, wherein the plurality of target data sources further comprises:
a dynamic social network of resources.

16. The computer program product of claim 13, wherein computer usable program code for synthesizing received data in the collection further comprises:
computer usable program code for processing the received data in the collection by one or more methods including data reduction, data transformation, data interpretation and data substitution.

17. The computer program product of claim 13, wherein computer usable program code for selecting a resource from the collection further comprises:
computer usable program code for adjusting criteria of a query to include weighting information;
computer usable program code for forming the query as a set of structured query language statements; and
computer usable program code for executing the set of structured query language statements against the collection.

18. The computer program product of claim 13, wherein the resource of the response is a “best fit” result.
